(19) United States
(12) Patent Application Publication
(10) Pub. No.: US 2026/0252938 A1
(43) Pub. Date: Aug. 27, 2026

(54) QUANTUM CIRCUIT APPARATUS AND CONTROL METHOD

(71) Applicant: NEC Corporation, Tokyo (JP)

(72) Inventor: Yohei KAWAKAMI, Tokyo (JP)

(73) Assignee: NEC Corporation, Tokyo (JP)

(21) Appl. No.: 19/541,648

(22) Filed: Feb. 17, 2026

(30) Foreign Application Priority Data
Feb. 27, 2025 (JP) 2025-030264

(51) Int. Cl. G06N 10/60

(52) U.S. Cl. CPC G06N 10/60

(57) ABSTRACT

A quantum circuit apparatus includes N qubits, where N is a predetermined integer of 3 or more, connected to a common node and configured to be coupled via a many-body interaction. The N qubits include at least one qubit with nonlinearity contributing to the many-body interaction and one or more qubits with nonlinearity not contributing to the many-body interaction.

### CROSS REFERENCE TO RELATED APPLICATIONS

The present application is based upon and claims the benefit of the priority of Japanese patent application No. 2025-030264, filed on Feb. 27, 2025, the disclosure of which is incorporated herein in its entirety by reference thereto.

### FIELD

The present disclosure relates to a quantum circuit apparatus and control method.

### BACKGROUND

In an LHZ (Lechner, Hauke, Zoller) scheme which is one approach to quantum annealing for solving combinatorial optimization problems, an interaction among quantum bits (qubits) such as a four-body interaction (Non-Patent Literature (NPL) 1) is required. Non-Patent Literature 2 discloses as a physical implementation of the LHZ scheme, a network illustrated in FIG. 1, which utilizes a four-body interaction among four qubits via a coupler. FIG. 1 is based on a of FIG. 4 in Non-Patent Literature 2. In the example illustrated in FIG. 1, a Josephson Parametric Oscillator (JPO) is used as a qubit, and a coupler is provided with a Josephson junction (JJ).
NPL 1: Lechner, Hauke, Zoller, “A quantum annealing architecture with all-to-all connectivity from local interactions”, Science Advances 23 Oct. 2015 Vol 1, Issue 9: DOI: 10.1126/sciadv. 1500838
NPL 2: Shruti Puri, Christian Kraglund Andersen, Arne L. Grimsmo, Alexandre Blais, “Quantum annealing with a network of all-to-all connected, two-photon driven Kerr nonlinear oscillators”, Nature Commun 8, 15785 (2017)

### SUMMARY

A qubit is a resonator with nonlinearity. The circuit in FIG. 1 exhibits two types of cross-Kerr interactions: a cross-Kerr interaction between qubits and a cross-Kerr interaction between a qubit and a coupler. The cross-Kerr interaction is known to produce an adverse effect on a circuit's operation, such as alteration of a resonance frequency of a qubit.

One of objects of the present disclosure is to provide a quantum circuit apparatus and a control method, each enabling to solve the above-described issue.

According to one aspect of the present disclosure, a quantum circuit apparatus includes N qubits, where N is a predetermined integer of 3 or more, connected to a common node and configured to be coupled via a many-body interaction. The N qubits include at least one qubit with nonlinearity thereof contributing to the many-body interaction; and one or more qubits with nonlinearity thereof not contributing to the many-body interaction.

According to one aspect of the present disclosure, there is provided a control method of a quantum circuit that includes N qubits, where N is a predetermined integer of 3 or more, enabled to be coupled via a many-body interaction, the method comprising:
configuring at least one qubit out of the N qubits with nonlinearity thereof contributing to the many-body interaction; and
configuring remaining one or more qubits out of the N qubits with nonlinearity thereof not contributing to the many-body interaction.

According to the present disclosure, there are provided an apparatus and a method, each enabling to suppress a c cross-Kerr interaction between a qubit and a coupler and/or a cross-Kerr interactions between qubits.

### BRIEF DESCRIPTION OF THE DRAWINGS

FIG. 1 is a diagram illustrating an example of the disclosure of Non-Patent Literature 2.

FIG. 2 is a diagram illustrating a configuration of at least an example of embodiments of the present disclosure.

FIG. 3 is a diagram illustrating a configuration of at least an example of embodiments of the present disclosure.

FIG. 4 is a diagram illustrating a configuration of at least an example of embodiments of the present disclosure.

FIG. 5 is a diagram illustrating a configuration of at least an example of embodiments of the present disclosure.

FIG. 6 shows an example of embodiments of the present disclosure.

FIG. 7 is a diagram illustrating a configuration of at least an example of embodiments of the present disclosure.

FIG. 8 is a diagram illustrating a configuration of at least an example of embodiments of the present disclosure.

FIGS. 9A through 9C are diagrams each illustrating a configuration of at least an example of embodiments of the present disclosure.

FIGS. 10A and 10B are diagrams each illustrating at least an example of embodiments of the present disclosure.

FIG. 11 is a diagram illustrating at least an example of embodiments of the present disclosure.

### EXAMPLE EMBODIMENTS

The following describes embodiments of the present disclosure. According to embodiments of the present disclosure, for example, with respect to four quantum bits (qubits) coupled via a four-body interaction, the number of qubits with nonlinearity contributing to the four-body interaction is limited using a coupling capacitance and/or a circuit structure. The present disclosure discloses a quantum circuit apparatus that is enabled to suppress a cross-Kerr interaction by appropriately combining qubits having different signs (polarities) in nonlinearity thereof.

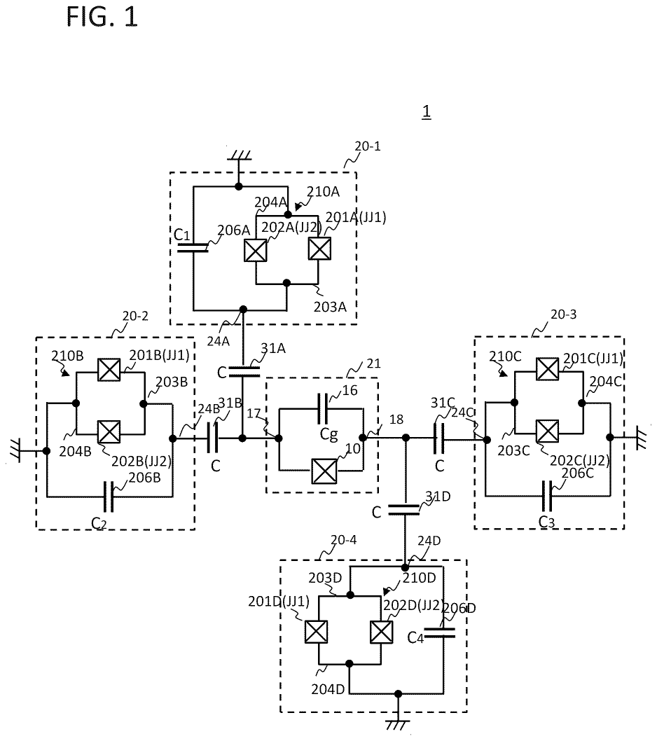

First, an analysis of a configuration shown in FIG. 1 is provided and its issue is described. Referring to FIG. 1, the quantum circuit apparatus 1 includes four qubits 20-1 to 20-4 and a coupler 21. More specifically, the first qubit 20-1 includes a superconducting member 203A that is set in a superconducting state at an extremely low (cryogenic) temperature, a Josephson junction 201A, a superconducting member 204A, and a Josephson junction 202A, which together form a loop constituting a SQUID 210A. The superconducting member 203A is connected to the electrode 24A, the superconducting member 204A is connected to ground, and a capacitor 206A (shunt capacitor) is connected in parallel with the SQUID 210A between the electrode 24A and ground. In operation, a magnetic flux penetrating the SQUID 210A is generated by a current provided by an unillustrated signal source to flow through an unillustrated inductor (magnetic field generation part). The resonance angular frequency ω₁ of the first qubit 20-1 is varied according to the magnetic flux penetrating the SQUID 210A. For the second through fourth qubits 20-2 to 20-4, respectively, superconducting members 203B to 203D corresponding to the superconducting member 203A of the first qubit 20-1, Josephson junctions 201B to 201D corresponding to Josephson junction 201A of the first qubit 20-1, superconducting members 204B 204D corresponding to the superconducting member 204A of the first qubit 20-1, Josephson junctions 202B to 202D corresponding to the Josephson junction 202A of the first qubit 20-1, SQUIDs 210B to 210D corresponding to the SQUID 210A of the first qubit 20-1, and capacitors 206B to 206D corresponding to the capacitor 206A of the first qubit 20-1 are provided. When operated, a magnetic flux penetrating each of the SQUIDs 210B to 210D is generated by a current flowing from an unillustrated signal source through an unillustrated inductor (magnetic field generation part) to ground. Resonance angular frequencies ω₂ to ω₄ of the second to fourth qubits 20-2 to 20-4 are varied according to the magnetic flux penetrating the SQUIDs 210B to 210D.

The coupler 21 includes a Josephson junction 10 and a capacitor 16 that are connected in parallel between a first electrode (first node) 17 and a second electrode (second node) 18. The first electrode 17 is coupled to the first qubit 20-1 and the second qubit 20-2 via coupling capacitors 31A and 31B (capacitive coupling), respectively, and the second electrode 18 is connected to the third qubit 20-3 and the fourth qubit 20-4 via coupling capacitors 31C and 31D (capacitive coupling), respectively. Note that in the following, when there is no need to discriminate a qubit, a branch number of a reference sign of the qubit is omitted, and a qubit is designated as a qubit 20. The same applies to other elements.

In the circuit shown in FIG. 1, there are two types of cross-Kerr interaction (abbreviated as “CKI”): one acting between qubits 20 (referred to as “QQ-CKI”) and one acting between a qubit 20 and a coupler 21 (referred to as “QC-CKI”).

QQ-CKI is proportional to a sum of nonlinearity of two qubits 20. QQ-CKI has 4!/2!=4×3/2=6 combinations (types), which are proportional to:

$$( {K}_{1} + {K}_{2} ) ;$$

$$( {K}_{1} + {K}_{3} ) ;$$

$$( {K}_{1} + {K}_{4} ) ;$$

$$( {K}_{2} + {K}_{3} ) ;$$

$$( {K}_{2} + {K}_{4} ) ; and$$

$$( {K}_{3} + {K}_{4} ) ,$$

where, Kᵢ (i=1, 2, 3, 4) is a parameter (or coefficient) representing nonlinearity (Kerr nonlinearity) of the i-th qubit 20-i.

Kᵢ is also referred to as a nonlinear parameter of the i-th qubit 20-i. Kᵢ may be corresponded to a Kerr nonlinearity Kᵢ in a Hamiltonian Hi of the i-th qubit (JPO) 20-i (i=1, 2, 3, 4) in FIG. 1, expressed as the following equation (1).

$$H i = Δ {a}_{i}^{+} {a}_{i} - {K}_{i} ( {a}_{i}^{+ 2} {a}_{i}^{2} ) + {E}_{p} ( {a}_{i}^{+ 2} + {a}_{i}^{2} ) \qquad ( 1 )$$

(1)

In equation (1),
Δ is the difference between a resonance angular frequency ω_{c} of the coupler 21 and half an angular frequency op of the i-th pump signal:

$$Δ = {ω}_{c} - ( 1 / 2 ) {ω}_{p} \qquad ( 2 )$$

Ep is the strength of the two-photon drive (pump term). aᵢ⁺ and aᵢ are creation and annihilation operators for bosons (photons) in the i-th qubit 20-i.

QC-CKI is proportional to the sum of the nonlinearity of the qubit 20 and the nonlinearity of the coupler 21. QC-CKI has four types corresponding to the first to fourth qubits 20-1 to 20-4, each proportional to:

$$( {K}_{1} + {K}_{g} ) ;$$

$$( {K}_{2} + {K}_{g} ) ;$$

$$( {K}_{3} + {K}_{g} ) ; and$$

$$( {K}_{4} + {K}_{g} ) ,$$

where K_{g} is a parameter (Kerr coefficient) representing the nonlinearity (Kerr nonlinearity) of the coupler 21. K_{g} is also referred to as the nonlinear parameter of the coupler 21.

As described before, a cross Kerr interaction is known to produce adverse effect on a circuit's operation, such as by altering the resonance frequency of qubit 20.

The above issue is one example, but according to the present disclosure, it is possible to suppress contribution of nonlinearity of a qubit(s) 20, in a many-body interaction among qubits 20 in various cases, not limited to the above.

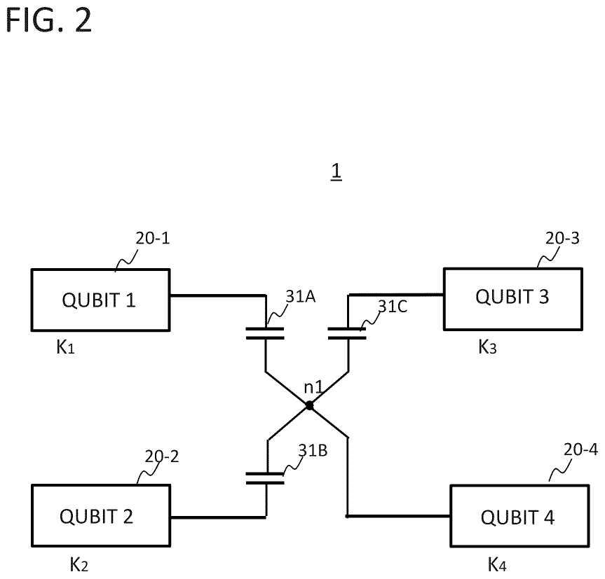

FIG. 2 is a schematic diagram illustrating at least an example of embodiments of the present disclosure. Referring to FIG. 2, a quantum circuit apparatus 1 includes first to fourth qubits 20-1 to 20-4, each equipped with a nonlinear resonant circuit, coupled via a four-body interaction. A three-body interaction, five-body interaction, or other interactions may also be employed.

In FIG. 2, the first qubit 20-1, second qubit 20-2 and third qubit 20-3 are connected in common to a node n1 via coupling capacitors 31A, 31B and 31C, respectively. The fourth qubit 20-4 is directly coupled to the node n1 (connected via direct wiring, etc.). The node n1, to which the first to fourth qubits 20-1 to 20-4 are commonly coupled, may be also referred to as a common node. In the circuit of FIG. 2, only the nonlinearity of the fourth qubit 20-4 contributes to the four-body interaction in the quantum circuit apparatus 1. Since the circuit of FIG. 2 does not contain a coupler, QC-CKI does not exist. However, as will be later-described, an approach adopted by the present disclosure may also be applied to the configuration of FIG. 1, where the first to fourth qubits 20-1 to 20-4 are connected to the coupler 21.

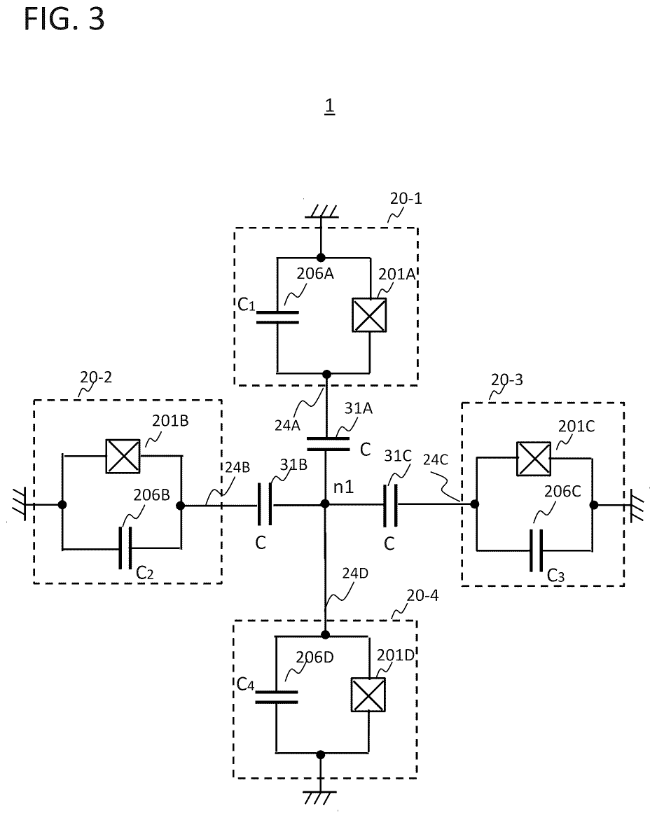

FIG. 3 illustrates an example circuit configuration of FIG. 2. In FIG. 3, the configuration of the first to fourth qubits 20-1 to 20-4 is identical to that in FIG. 1, and the description thereof is omitted. Referring to FIG. 3, the coupler 21 of FIG. 1 is not provided. Furthermore, while the first to third qubits 20-1 to 20-3 are capacitively coupled (AC coupled) to the common node n1 via coupling capacitors 31A to 31C, the fourth qubit 20-4 is directly coupled (DC coupled) to the common node n1. In the quantum circuit apparatus 1, only the nonlinearity (Kerr nonlinearity) of the fourth qubit 20-4 contributes to a coupling coefficient (h⁽⁴⁾) of the four-body interaction induced by nonlinearity of the qubits 20.

The coupling coefficient (strength) of the four-body interaction h⁽⁴⁾ induced by nonlinearity of the qubits 20 may be expressed (approximated) by the following equation (3), as an example.

$${\tilde{h}}^{( 4 )} ≃ - 2 {g}_{12} {g}_{13}^{2} \frac{{K}_{4}}{{Δ}_{13} {Δ}_{14} {Δ}_{34}} \qquad ( 3 )$$

In equation (3),
gᵢⱼ represents an interaction between the i-th qubit 20-i and the j-th qubit 20-j (i≠j=1, 2, 3, 4). In equation (3), g12 and g13 appear. Δᵢⱼ represents the difference in resonance angular frequency between the i-th qubit 20-i and the j-th qubit 20-j (i≠j=1, 2, 3, 4). In equation (3), Δ13, Δ14, and Δ34 appear.
K₄ is the nonlinear parameter of the fourth qubit 20-4.

In equation (3), the nonlinear parameters K₁, K₂, K₃ of the first, second, and third qubits 20-1, 20-2, 20-3 do not contribute to the coupling strength (coefficient) h⁽⁴⁾ due to the four-body interaction. Therefore, these nonlinear parameters K₁, K₂, and K₃ may take any values. For example, the nonlinear parameters for the first to fourth qubits 20-1 to 20-4 may be identical, i.e., K₁=K₂=K₃=K₄.

In this case, the first to fourth qubits 20-1 to 20-4 may have identical nonlinear parameters K₁ to K₄ and identical layouts and configurations. Note that in FIG. 3, as explained with reference to FIG. 2, the QC-CKI does not exist since no coupler is included.

When the nonlinear parameters K₁ to K₄ of the first to fourth qubits 20-1 to 20-4, are configured, for example, as follows:

$${K}_{1} = {K}_{2} = {K}_{3} = K , {K}_{4} = - K \qquad ( 4 )$$

(K₁+K₄), (K₂+K₄), and (K₃+K₄) all become zero, thereby canceling out related QQ-CKIs to suppress contribution (effect) to the four-body interaction. Alternatively, by assigning a sign to K₄ opposite to signs of K₁, K₂, and K₃, values of (K₁+K₄), (K₂+K₄), and (K₃+K₄) each can be reduced.

Here, the four-body interaction among the four qubits 20 arises not from the coupler 21 (in FIG. 1), but from the nonlinearity (Kerr nonlinearity) of the qubits 20. Referring again to FIG. 3, a coupling coefficient h⁽⁴⁾ for the four-body interaction arising from nonlinearities between qubits 20 can be expressed (or approximated) as follows, for example:

$$\frac{{h}^{( 4 )}}{2} ≃ {\sum }_{i = 1}^{4} {\prod }_{{j = 1}_{( j \neq i )}}^{4} ( \frac{{g}_{i j}}{{Δ}_{j i}} ) {K}_{i} \qquad ( 5 )$$

In equation (5),
gᵢⱼ (i≠j=1, 2, 3, 4) represents the strength (magnitude) of the coupling between the i-th qubit 20-i and the j-th qubit 20-j.
Δⱼᵢ (i≠j=1, 2, 3, 4) is the difference ωⱼ−ωᵢ between the resonance angular frequency ωⱼ of the j-th qubit 20-j and the resonance angular frequency ωᵢ of the i-th qubit 20-i.
Kᵢ (i=1, 2, 3, 4) is the nonlinear parameter of the i-th qubit 20-i.

In equation (5), a multiplication term:

$${{\prod }^{4}}_{{j = 1}_{( j \neq i )}} ( \frac{{g}_{i j}}{{Δ}_{j i}} ) {K}_{i}$$

can be expressed by the following expression (6), when gᵢⱼ (j=1, 2, 3, 4 (j≠i)) is denoted as g, Δⱼᵢ (j=1, 2, 3, 4 (ji)) as Δ, and K_{q} as an effective value of gᵢⱼ/Δⱼᵢ (an effective Kerr coefficient remaining after terms of signs ± are cancelled out).

$${( \frac{g}{Δ} )}^{3} {K}_{q} \qquad ( 6 )$$

In expression (6), the following is assumed.

$$\frac{g}{Δ} < 1 \qquad ( 7 )$$

Under the above condition, making the difference Δ in the resonance angular frequency between two qubits (the i-th qubit 20-i and j-th qubit 20-j) as small as possible, may contribute to increasing the value of equation (7).

From expression (6), increasing the parameter K_{q} representing the nonlinearity of qubit 20 also increases a value of the coupling coefficient h⁽⁴⁾ of the four-body interaction. In expression (6), the nonlinear parameter K_{q} of qubit 20 is multiplied by (g/Δ) (<1) to the power of three term (g/Δ)³. Therefore, the coupling coefficient h⁽⁴⁾ for the four-body interaction due to the nonlinearity of qubit 20 can be made relatively large compared to g⁽⁴⁾ in FIG. 1, as described below.

A strength (coupling coefficient) g⁽⁴⁾ of the four-body interaction in FIG. 1 is given, for example, by the following equation (8) (Non-Patent Literature 2).

$${g}^{( 4 )} = {K}_{g} \frac{{g}_{1} {g}_{2} {g}_{3} {g}_{4}}{{Δ}_{1} {Δ}_{2} {Δ}_{3} {Δ}_{4}} \qquad ( 8 )$$

Here, K_{g} is a parameter representing the nonlinearity of the coupler 21 (nonlinear parameter).
Δᵢ (i=1, 2, 3, 4) is a difference (detuning) between a resonance angular frequency ω_{c} of the coupler and a resonance angular frequency Di of the i-th qubit 20-i (=ω_{c}−ωᵢ).
gᵢ (i=1, 2, 3, 4) represents a coupling strength between the i-th qubit 20-i and the coupler 21.

From equation (8), under a condition:

$$\frac{{g}_{i}}{{Δ}_{i}} < 1 ( i = 1 , 2 , 3 , 4 ) \qquad ( 9 )$$

by reducing the detuning Δi as small as possible, the coupling coefficient g⁽⁴⁾ for the four-body interaction becomes large, and the four-body interaction is strengthened. Therefore, the resonance angular frequency ωᵢ (i=1, 2, 3, 4) of each qubit and the resonance angular frequency ω_{c} of the coupler need to be sufficiently close. In equation (8), approximating gᵢ/Δᵢ (i=1, 2, 3, 4) with g/Δ implies that the strength of the four-body interaction coupling via the coupler 21 is multiplied by the nonlinear parameter K_{g} of the coupler 21, along with a fourth-power term of (g/Δ): (g/Δ)⁴. Thus, because the nonlinear parameter K_{g} of the coupler 21 is multiplied by (g/A) (<1) to the power of fourth (g/Δ)⁴, the coupling coefficient g⁽⁴⁾ for the four-body interaction in equation (8) can only take a small value.

Equation (3), which represents the four-body interaction due to nonlinearity among four qubits 20, does not involve a parameter related to the coupler (e.g., 21 in FIG. 1). Therefore, in the present disclosure, adjusting a resonance frequency of the coupler 21 in FIG. 1 or similar operation is not required to enhance the four-body interaction. There is no need to install a signal source, control lines, input/output lines, and measuring instruments required to vary a resonance frequency of the coupler. Note that while a parameter related to the coupler do not appear in equation (3) representing the four-body interaction, the coupler can generate an interaction including the four-body interaction among the four qubits, allowing the four-body interaction expressed by equation (3) to coexist. In this case, the strength of the four-body interaction coupling is given by h (4)+g⁽⁴⁾ (it may also be the sum of the absolute values of h⁽⁴⁾ and g⁽⁴⁾).

In equation (5), focusing on i=1, i.e., the first qubit 20-1 in FIG. 3, regarding:
the difference Δ₂₁ in resonance angular frequency between the second qubit 20-2 and the first qubit 20-1 (=ω₂−ω₁), and the coupling strength g12 between the first qubit 20-1 and the second qubit 20-2;
the difference Δ₃₁ between the resonance angular frequencies of the third qubit 20-3 and the first qubit 20-1 (=ω₃−ω₁), and the coupling strength g₁₃ between the first qubit 20-1 and the third qubit 20-3; and
the difference Δ₄₁ in the resonance angular frequency between the fourth qubit 20-4 and the first qubit 20-1 (=ω₄−ω₁), and the coupling strength g₁₄ between the first qubit 20-1 and the fourth qubit 20-4, the product term for i=1 in equation (5) is given as follows:

$$( \frac{{g}_{12}}{{Δ}_{21}} ) ( \frac{{g}_{13}}{{Δ}_{31}} ) ( \frac{{g}_{14}}{{Δ}_{41}} ) {K}_{1} \qquad ( 10 )$$

Expanding equation (5) for the first to fourth qubits 20-1 to 20-4 in FIG. 3, we have the following equation (11).

$${h}^{( 4 )} = 2 ( {K}_{1} \frac{{g}_{21}}{{Δ}_{21}} \frac{{g}_{31}}{{Δ}_{31}} \frac{{g}_{41}}{{Δ}_{41}} + {K}_{2} \frac{{g}_{12}}{{Δ}_{12}} \frac{{g}_{32}}{{Δ}_{32}} \frac{{h}_{42}}{{Δ}_{42}} + {K}_{3} \frac{{g}_{13}}{{Δ}_{13}} \frac{{g}_{23}}{{Δ}_{23}} \frac{{g}_{43}}{{Δ}_{43}} + {K}_{4} \frac{{g}_{14}}{{Δ}_{14}} \frac{{g}_{24}}{{Δ}_{24}} \frac{{g}_{34}}{{Δ}_{34}} ) \qquad ( 11 )$$

Equation (5) is a generalization of equation (11).

In equation (11), a condition for the first to fourth qubits 20-1 to 20-4 to exhibit the four-body interaction (the condition concerning the resonance angular frequencies ω₁ to ω₄) may be expressed as:

$${ω}_{1} + {ω}_{2} = {ω}_{3} + {ω}_{4} \qquad ( 12 )$$

From equation (12)

$${ω}_{3} - {ω}_{1} = - ( {ω}_{4} - {ω}_{2} )$$

$${ω}_{4} - {ω}_{1} = - ( {ω}_{3} - {ω}_{2} )$$

Therefore,

$${Δ}_{13} = - {Δ}_{24} , {Δ}_{14} = - {Δ}_{23} \qquad ( 13 )$$

Here, the coupling constant g₁₂ between the first and second qubits 20-1 and 20-2, and the coupling constant g₃₄ between the third and fourth qubits 20-3 and 20-4, can be approximated as equal to each other when their respective resonance angular frequencies are close.

$${g}_{12} = {g}_{34} \qquad ( 14 )$$

The coupling constant g₁₃ between the first and third qubits 20-1 and 20-3 coupled via the node (common node) n1, the coupling constant g₁₄ between the first and fourth qubits 20-1 and 20-4 coupled via the node n1, the coupling constant g₂₃ between the second and third qubits 20-2 and 20-3 coupled via the node n1, and the coupling constant g₂₄ between the second and fourth qubits 20-2 and 20-4 coupled via the node n1 are assumed to be equal to each other, when respective resonance angular frequencies thereof are close.

$${g}_{13} = {g}_{14} = {g}_{23} = {g}_{24} \qquad ( 15 )$$

Therefore,

$${g}_{14} {g}_{24} {g}_{34} = {g}_{13} {g}_{13} {g}_{12} = {g}_{12} {g}_{13}^{2} \qquad ( 16 )$$

$${Δ}_{13} = - {Δ}_{24} \qquad ( 17 )$$

Using equations (13) through (17), the fourth term on the right-hand side of equation (11) leads to equation (3), repeated as below.

$${\tilde{h}}^{( 4 )} = 2 ( \frac{{g}_{14}}{{Δ}_{14}} ) ( \frac{{g}_{24}}{{Δ}_{24}} ) ( \frac{{g}_{34}}{{Δ}_{34}} ) {K}_{4} = - 2 {g}_{12} {g}_{13}^{2} \frac{{K}_{4}}{{Δ}_{13} {Δ}_{14} {Δ}_{34}} \qquad ( 3 )$$

The nonlinear parameter Kᵢ of qubits 20-i (i=1, 2, 3, 4) can be broadly categorized into a component determined by an inductance and a component determined by a capacitance. For example, nonlinear parameter Kᵢ may be expressed by the following equation (18).

$${K}_{i} = {p}_{i} {E}_{C i} \qquad ( 18 )$$

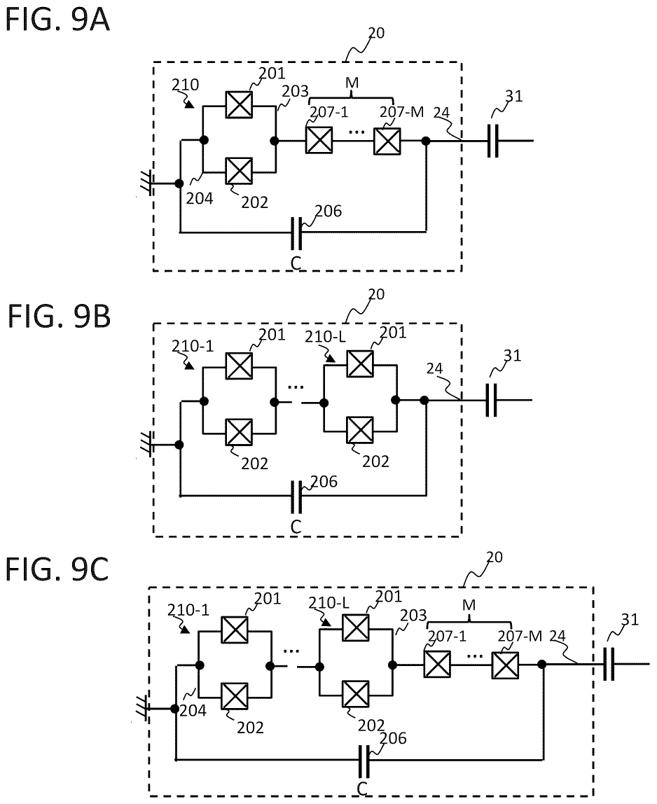

In equation (18),
pᵢ (Participation ratio) is a ratio of an inductive energy stored in the qubit (Josephson junction) to an inductive energy stored in the circuit, and may be given, for example, as follows.

$${p}_{i} = \frac{{n}_{iS} {L}_{iS}^{3} + {n}_{iJ} {L}_{iJ}^{3}}{{( {L}_{iL} + {n}_{iS} {L}_{iS} + {n}_{iJ} {L}_{iJ} )}^{3}} \qquad ( 19 )$$

Where,
L_{iL} (i=1, 2, 3, 4) is a structural inductance of the i-th qubit 20-i,
L_{iS} (i=1, 2, 3, 4) is an inductance of a SQUID for the i-th qubit 20-i,
n_{iS} (i=1, 2, 3, 4) is the number of SQUIDs in the i-th qubit 20-i (FIG. 9B),
L_{iJ} (i=1, 2, 3, 4) is an inductance of a Josephson junction connected in series with the SQUID in the i-th qubit 20-i (FIG. 9A, FIG. 9C), and
n_{iJ} (q=1, 2, 3, 4) is the number of Josephson junctions connected in series in the i-th qubit 20-i.

E_{C}_{ᵢ} in equation (18) may be given by the following equation (20).

$${E}_{Ci} = \frac{{e}^{2}}{2 {C}_{i}} \qquad ( 20 )$$

$$( i = 1 , 2 , 3 , 4 )$$

Where e is the elementary charge, and Cᵢ is an effective structural capacitance of qubit 20. For example, Cᵢ may be a capacitance of a capacitor 206 (shunt capacitor) of the i-th qubit 20-i.

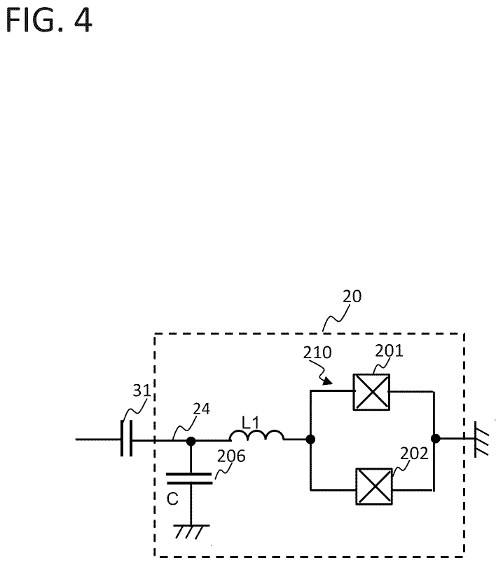

FIG. 4 illustrates a structural inductance of the SQUID 210 in the qubit 20. A maximum value of pᵢ (i=1, 2, 3, 4) in Equation (19) is 1. To bring pᵢ closer to its maximum value, the structural inductance Lᵢ (inductance L1 in FIG. 4) needs to be reduced as much as possible.

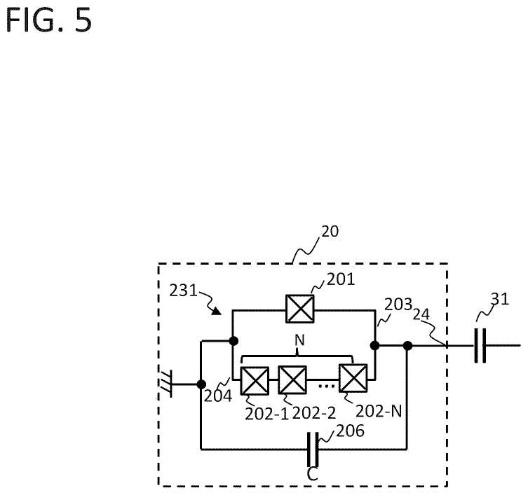

At least one of the four qubits 20 in FIG. 2 may be configured as a JPO including a SNAIL (Superconducting Nonlinear Asymmetric Inductive eLement), as illustrated in FIG. 5. Referring to FIG. 5, a SNAIL 231 may include a small Josephson junction 201 in parallel with large Josephson junctions 202-1 to 202-N connected in series in a large number N (N≥1). A Josephson energy E_{J} of Josephson junction 201 is a times (0<α<1) a Josephson energy E_{J} of each Josephson junction 202-1 to 202-N. Since the Josephson energy is proportional to a critical current, a critical current of Josephson junction 201 is a times (0<α<1) a critical current I_{c} of each Josephson junction 202-1 to 202-N. A value of the critical current of a Josephson junction is proportional to a junction size (junction area) of a Josephson junction. Therefore, a junction size of the Josephson junction 201 is smaller than each of junction sizes of Josephson junctions 202-1 to 202-N. The junction size of Josephson junction 201 is a times (0<α<1) the each of junction sizes of Josephson junctions 202-1 to 202-N. Connecting Josephson junctions 202-1 to 202-N in series may contribute to reduction nonlinearity of the SNAIL 231.

The nonlinear parameter Kᵢ (i=1, . . . , 4) representing the nonlinearity (Kerr nonlinearity) of the i-th qubit 20-i using a SNAIL, may be expressed by equation (22), when a Hamiltonian Hᵢ of the qubit 20-i may be given by equation (21) (Reference Literature 1).

$${H}_{i} = {ω}_{i} {a}_{i}^{†} {a}_{i} + {{g}_{3 i} ( {a}_{i} + {a}_{i}^{†} )}^{3} + {{g}_{4 i} ( {a}_{i} + {a}_{i}^{†} )}^{4} , \qquad ( 21 )$$

In equation (21), ai⁺ and ai are creation and annihilation operators for bosons in the i-th qubit 20-i.

$${K}_{i} = 12 ( {g}_{4 i} - \frac{5 {g}_{3 i}^{2}}{{ω}_{i}} ) \qquad ( 22 )$$

where ωᵢ is a resonance angular frequency of the i-th qubit 20-i.

Similarly, the parameter (Kerr coefficient) (nonlinear parameter) K_{g} representing a nonlinearity of the coupler 21 using a SNAIL may be expressed by the following equation (23).

$${K}_{g} = 12 ( {g}_{4 g} - \frac{5 {g}_{3 g}^{2}}{{ω}_{g}} ) \qquad ( 23 )$$

ω_{g} is a resonance angular frequency of the coupler 21.

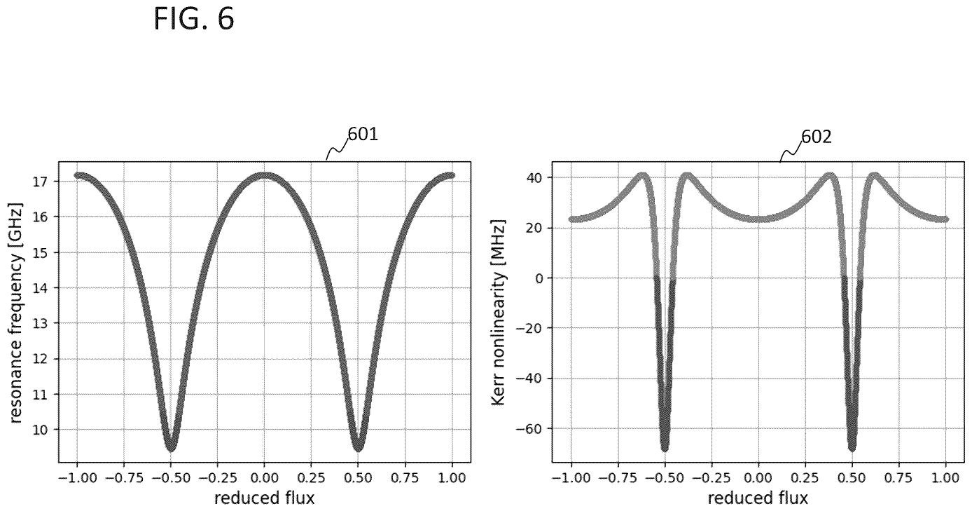

FIG. 6 shows an example of a magnetic field characteristic of the resonance frequency (GHz (Giga-Hertz)) (magnetic field response) 601 of a SNAIL and a magnetic field characteristic of the Kerr nonlinearity (MHz (Mega-Hertz)) (magnetic field response) 602 of a SNAIL. In graphs 601 and 602, a horizontal axis is a reduced flux (ω/Φ₀, where Φ₀ is a magnetic flux quantum). For a JPO using a SNAIL with a negative nonlinear parameter, K becomes the minimum (locally minimum) when the magnitude of the applied magnetic flux is at a position where the resonance frequency of the JPO using the SNAIL (qubit) takes a minimum value (magnetic flux Φ=±0.5Φ₀ (half-integer) (where do is a magnetic flux quantum Φ₀=h/2e)). JPO using a SNAIL with a positive nonlinear parameter K operates outside the ±0.5 (half-integer) range of the applied magnetic flux Φ=0.4 to −0.4Φ₀, 0.6 to 1.4Φ₀, −0.6 to −1.4Φ₀). Note that a SQUID cannot change the sign of the nonlinear parameter in the applied magnetic field.

The approach described above (canceling nonlinear parameters using positive and negative nonlinear parameters) is also applicable to the circuit of FIG. 1 equipped with coupler 21. As described before, in FIG. 1, there are six types of QQ-CKI proportional to (K₁+K₂), (K₁+K₃), (K₁+K₄), (K₂+K₃), (K₂+K₄), and (K₃+K₄).

By configuring

$${K}_{1} = {K}_{4} = - K , {K}_{2} = {K}_{3} = K \qquad ( 24 )$$

the four types of QQ-CKI proportional to

$$( {K}_{1} + {K}_{2} ) ,$$

$$( {K}_{1} + {K}_{3} ) ,$$

$$( {K}_{2} + {K}_{4} ) ,$$

$$and$$

$$( {K}_{3} + {K}_{4} )$$

become 0 (cancel out).

However, the two types of QQ-CKI proportional to (K₁+K₄) and (K₂+K₃) remain.

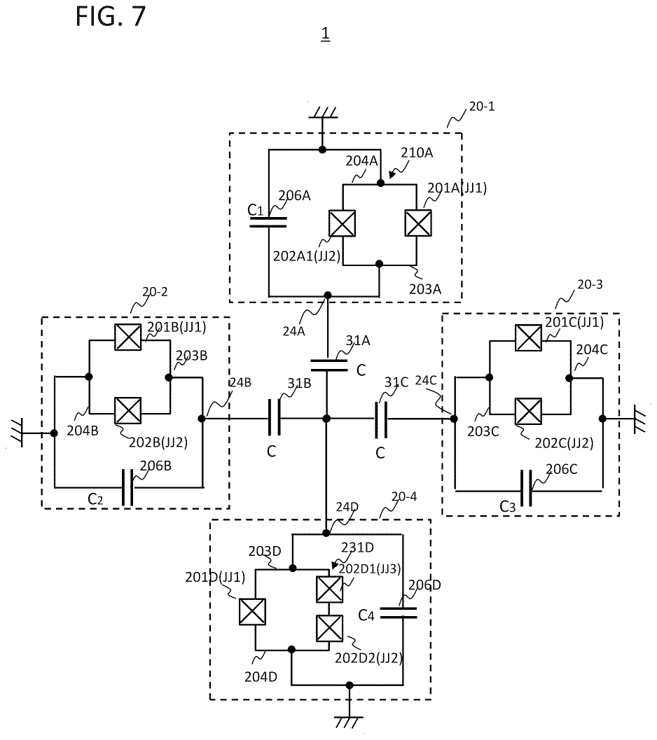

FIG. 7 illustrates an example where in the circuit of FIG. 3, the fourth qubit 20-4 is configured using a JPO with a SNAIL, while the first qubit 20-1, second qubit 20-2, and third qubit 20-3 are configured using JPOs with SQUIDs. The nonlinear parameters K₁, K₂, and K₃ of the first to third qubits 20-1 to 20-3 are set to Kᵢ=K₂=K₃=K (e.g., a positive value), and the nonlinear parameter K₄ of the fourth qubit 20-4 is set to K₄=−K (negative value). This ensures that (K₁+K₄), (K₂+K₄), and (K₃+K₄) all become zero, QQ-CKI being successfully canceled.

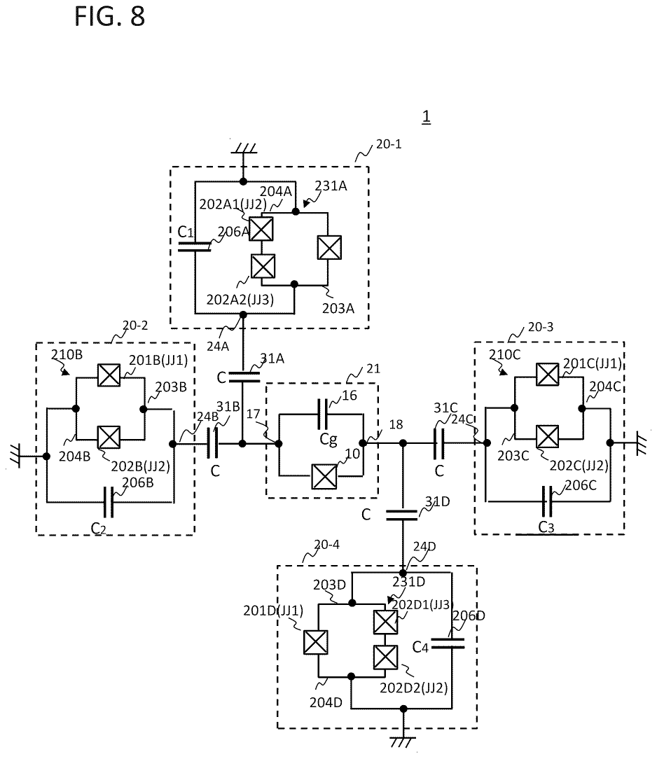

FIG. 8 illustrates an example configuration designed to reduce an effect of cross-Kerr interaction in the circuit configuration of FIG. 1. Referring to FIG. 8, the first qubit 20-1 and the fourth qubit 20-4 in FIG. 1 are implemented as JPOs with SNAILs, while the second qubit 20-2 and the third qubit 20-3 are implemented as JPOs with SQUIDs. For the nonlinear parameters of the second and third qubits 20-2 and 20-3, by setting K₂=K₃=K (e.g., positive value), and for the nonlinear parameters of the first and fourth qubits 20-1 and 20-4, by setting K₁=K₄=−K (negative value),

$$( {K}_{1} + {K}_{2} ) ;$$

$$( {K}_{1} + {K}_{3} ) ;$$

$$( {K}_{2} + {K}_{4} ) ;$$

$$and$$

$$( {K}_{3} + {K}_{4} )$$

all become zero. This allows four out of the six possible combinations of the sum of the nonlinear parameters for the two qubits 20 to be effectively cancelled out. Furthermore, by setting the nonlinear parameter K_{g} of the coupler 21 to K,

$$( {K}_{1} + {K}_{g} )$$

$$and$$

$$( {K}_{4} + {K}_{g} )$$

both become zero. This allows two of the four combinations of the sum of the nonlinear parameters of the qubit 20 and the coupler 21 to be effectively canceled out.

In FIG. 8, a magnetic field (magnetic flux) applied to a SNAIL 231A of the first and fourth qubit 20-1, and a SNAIL 231D of the fourth qubit 20-4 are set to such a magnetic field (magnetic flux) where the nonlinearity becomes negative in the magnetic field characteristic (magnetic field response) 602 of the nonlinear parameters of the SNAIL structure shown in FIG. 6 (magnetic field characteristic 602 in FIG. 6). The first and fourth qubits (JPO) 20-1 and 20-4, including SNAIL 231A and 231D, oscillate (parametric oscillation) due to AC signals capacitive coupled thereto. For example, an AC signal (at twice the resonance frequency) is supplied via capacitive coupling to the electrodes 24A and 24D of the first qubit 20-1 and the fourth qubit 20-4, respectively, from signal sources (not shown). Magnetic fields (DC magnetic field+AC magnetic field (frequency approximately twice the resonance frequency)) are applied to the SQUIDs 210B and 210C of the second and third qubits 20-2 and 20-3, respectively, from unillustrated magnetic field application parts, causing them to oscillate (parametric oscillation) at a predetermined resonance frequency.

In the configuration of FIG. 8, the coupling coefficient h⁽⁴⁾ of the four-body interaction due to a nonlinearity of a qubit 20 (e.g., equation (9)) and a coupling strength g⁽⁴⁾ of the four-body interaction of qubits 20 via the coupler 21 (e.g., equation (8)) may be combined as a coupling strength of the four-body interaction.

As a configuration for altering nonlinearity in the first to fourth qubits 20-1 to 20-4, a configuration such as those shown in FIG. 9A, FIG. 9B, or FIG. 9C may also be used. FIG. 9A illustrates a configuration of a qubit 20 where the number M of Josephson junctions 207-1 to 207-M are connected in series with the SQUID 210 between the electrode 24 and ground. By changing the number M of Josephson junctions 207-1 to 207-M, the nonlinearity (Kerr nonlinearity) of the qubit 20 can be altered. For example, as the number M increases, the nonlinearity decreases. FIG. 9B illustrates a configuration of a qubit 20 where the number L of SQUIDs 210-1 to 210-L are connected in series between the electrode 24 and ground. By changing the number L of SQUIDs 210-1 to 210-L, the nonlinearity (Kerr nonlinearity) of the qubit 20 can be altered. As the number L increases, nonlinearity decreases. FIG. 9C illustrates a configuration of a qubit 20 where the number M of Josephson junctions 207-1 to 207-M are connected in series with the number L of SQUIDs 210-1 to 210-L between the electrode 24 and ground. By changing the number L of SQUIDs 210-1 to 210-L and the number M of Josephson junctions 207-1 to 207-M, the nonlinearity (Kerr nonlinearity) of the qubit 20 can be altered.

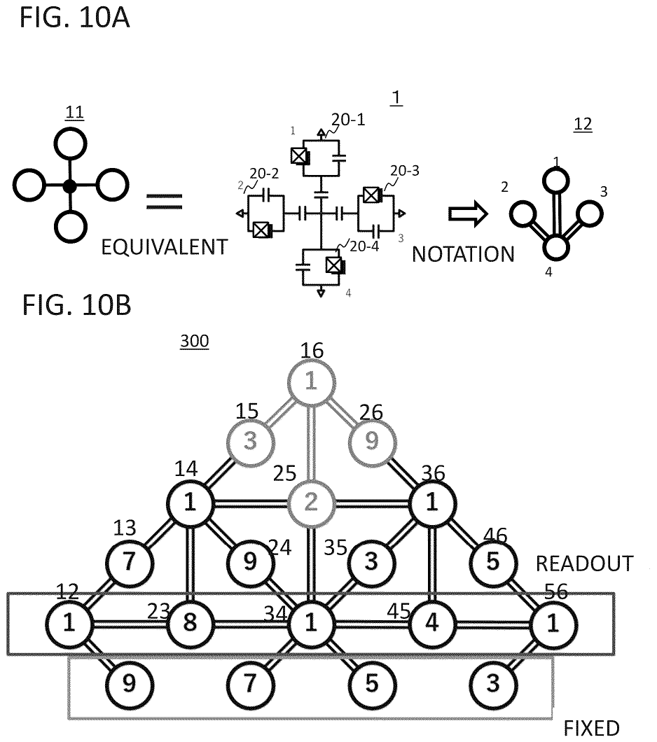

The quantum circuit apparatus 1 including four qubits 20-1 to 20-4 connected to the common node n1 of the embodiments described above with reference to FIGS. 2 and 3 may be represented as shown by a reference number 11 in FIG. 10A or as shown by a reference number 12. In the circuit of the reference number 12, double lines between qubits indicated by white circles represent a line (wiring) with a coupling capacitor.

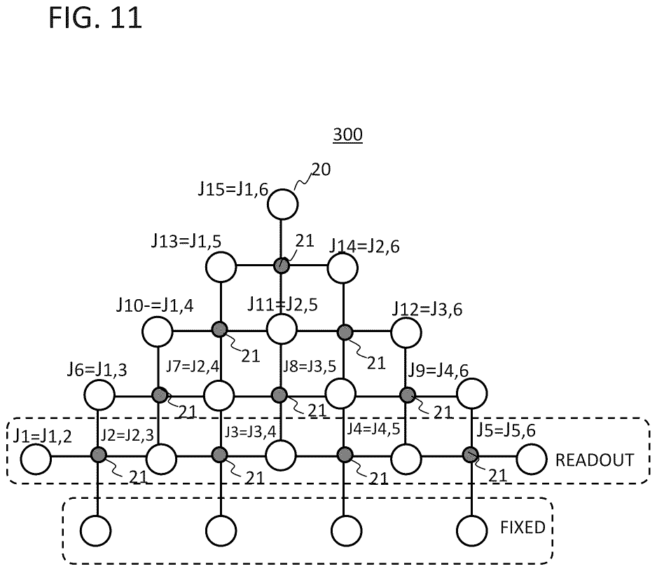

FIG. 10B is a diagram illustrating an example configuration of a four-body coupled quantum computing apparatus (quantum annealing machine) 300. FIG. 10B illustrates a configuration where the circuit configuration of the embodiment described with reference to FIGS. 2, 3, 7, etc., as a basic circuit (basic unit), is extended to multiple bits. As illustrated in FIG. 10B, the basic circuit can be expanded to construct a large-scale circuit. In FIG. 10B, each circle represents a qubit 20, which is a physical qubit. In FIG. 10B, two numbers (digits) attached to each circle (physical qubit) represent two logical bits (“ij” in Jᵢⱼ of Equation (25)). Nine distinct frequencies are assigned to prevent an occurrence of an extra four-body interaction, and the numbers 1 to 9 within each circle (physical qubit) represent labels for the nine different frequencies. The bottom row of four qubits holds fixed values, and a solution to the optimization problem is read out from the rows above. A quantum annealing machine 300 illustrated in FIG. 10B is equivalent to a configuration illustrated in FIG. 11, which illustrates an example of a physical implementation of the LHZ scheme (logical bit count N=6, physical bit count=15) disclosed in NPLs 1 and 2, etc. FIG. 11 illustrates a configuration of a quantum computing apparatus (quantum annealing machine) 300, which includes four qubits 20 and a coupler 21 as a unit (plaquette).

A Hamiltonian for all-to-all Ising spin glass model may be given as the following equation.

$${H}_{f} = {\sum }_{i = 1}^{N - 1} {\sum }_{i < j}^{N} {J}_{ij} {σ}_{z}^{( i )} {σ}_{z}^{( j )} + {\sum }_{i = 1}^{N} {b}_{i} {σ}_{z}^{( i )} \qquad ( 25 )$$

(where σ⁽ⁱ⁾_{Z} is a spin operator (Pauli matrix z-component), Jᵢⱼ is an interaction coefficient, and bi is a local magnetic field.)

Equation (25) may be expanded to a physical qubit Hamiltonian given by the following equation (26), with K=N(N−1)/2 (for N=6, K=15).

$${H}_{p} = {\sum }_{k = 1}^{K} {J}_{k} {\tilde{σ}}_{Z}^{( k )} + {\sum }_{l = 1}^{K - N + 1} {C}_{l} = {\sum }_{k = 1}^{K} {J}_{k} {\tilde{σ}}_{Z}^{( k )} - ( C {\sum }_{l = 1}^{K - N + 1} {\tilde{σ}}_{z}^{( l , n )} {\tilde{σ}}_{z}^{( l , e )} {\tilde{σ}}_{z}^{( l , s )} {\tilde{σ}}_{z}^{( l , w )} ) \qquad ( 26 )$$

The interaction coefficient (matrix) Jᵢⱼ of the fully connected Ising spins in equation (25) is transformed to a local magnetic field Jₖ acting on a physical qubit in the Hamiltonian of equation (26). C₁ in equation (26) is a constraint (see NPL 1). In equation (26),

$${\tilde{σ}}_{Z}^{( k )}$$

is a kth physical spin (Pauli matrix z component). C₁ (1∈{1, . . . , K−N+1}) in equation (26) are constructed from conditions on closed loops of logical qubits with necessary requirements (i) that the constraints cover all physical qubits and (ii) that the number of constraints is at least K−N. Note that (1,n), (1,e), (1,s), (1,w) represent the 1-th plaquette (a region enclosed by four physical qubits connected to a coupler 21, where n, e, s, w denote the four physical qubits located east, west, south, and north relative to node n1.)

In FIG. 11, gray circles each represent a coupler 21, while four white circles surrounding the coupler 21 represent four qubits (physical qubits) 20. FIG. 11 illustrates four nearest-neighbor qubits 20 coupled with the four-body interaction via the coupler 21 to form a unit cell (plaquette). FIG. 11 corresponds to an all-to-all-connected quantum annealing machine, where the four qubits in a bottom row are fixed values, and a solution to the optimization problem is read out from the row one above the bottom.

In the present disclosure, a quantum circuit apparatus may be integrated as a chip. In this case, a substrate may be silicon (Si), for example, but other electronic materials such as sapphire or compound semiconductor materials (Group IV, Group III-V, Group II-VI) may also be used. Furthermore, while a single-crystal substrate is preferable for a quantum chip, a polycrystalline or amorphous substrate may also be used. Wiring layer pattern on a quantum chip may be formed by deposition (vapor-deposition) of a superconducting material onto a substrate surface and then patterning thereof. As for a superconducting material(s) (interconnect material(s)) used in an interconnect(s) and an electrode(s) in an interconnect layer of a quantum chip, a material(s) such as Nb (niobium) or Al (aluminum) may be employed, though not limited thereto. Niobium nitride, indium (In), lead (Pb), tin (Sn), rhenium (Re), palladium (Pd), titanium (Ti), titanium nitride, molybdenum (Mo), tantalum (Ta), tantalum nitride, and alloys including at least one of these, or any other metal that is made in a superconducting state when cooled to an extremely low temperature (cryogenic temperature). As a Josephson junction, a first aluminum film may be formed on a surface of a substrate of a quantum chip by a first oblique epitaxy, oxidized to form a tunnel oxide film (AlOₓ), and a second aluminum film may be formed by a second oblique epitaxy from an opposite direction to the first oblique epitaxy, thereby forming a Josephson junction (Al/AlOₓ/Al).

While a SQUID and a SNAILs were used as examples of a nonlinear element for a qubit 20 and a coupler 21, ATS (Asymmetrically Threaded SQUID) or STS (Symmetrically Threaded SQUID) may also be used. Alternatively, any other configuration of a Josephson junction may be employed. For example, a qubit 20 may also include a transmon including a Josephson junction and a capacitor.

Furthermore, a cross-Kerr nonlinear interaction described above is not limited to a superconducting quantum circuit, and may be also applicable to a cross-Kerr nonlinear interaction between an optical cavity and a microwave. That is, while a JPO is used as an example to illustrate a Kerr parametric oscillator (KPO) with a Kerr effect, it goes without saying that qubits 20-1 to 20-4 may also be implemented using KPO other than JPO.

### [Reference Literature 1]

Timo Hillmann, Fernando Quijandria, “Designing Kerr Interactions for Quantum Information Processing via Counterrotating Terms of Asymmetric Josephson-Junction Loops”, Phys. Rev. Applied 17, 064018—Published 9 Jun. 2022

The above embodiments/examples may be listed as the following supplementary notes (Notes), though not limited thereto.

(Note 1) A quantum circuit apparatus includes N qubits, where N is a predetermined integer of 3 or more, connected to a common node and configured to be coupled via a many-body interaction. The N qubits include at least one qubit whose nonlinearity contributes to the many-body interaction and one or more qubits whose nonlinearity does not contribute to the many-body interaction.

(Note 2) In the quantum circuit apparatus according to Note 1, the N is set to 4, the many-body interaction is a four-body interaction of four qubits, wherein among the four qubits, at least one qubit is directly coupled to the common node, while remaining qubits are capacitively coupled to the common node.

(Note 3) In the quantum circuit apparatus according to Note 1 or 2, the qubit includes a Josephson junction and/or a superconducting quantum interference device (SQUID) including multiple Josephson junctions within a loop.

(Note 4) In the quantum circuit apparatus according to Notes 2 or 3, the coupling coefficient h⁽⁴⁾ for the four-body interaction, where an i-th qubit is directly coupled to the common node as at least one of the four qubits, is given by the following approximation:

$${\tilde{h}}^{( 4 )} ≃ 2 {g}_{12} {g}_{13}^{2} \frac{{K}_{i}}{{Δ}_{li} {Δ}_{mi} {Δ}_{ni}}$$

where gᵢⱼ is a coupling strength between the i-th and j-th qubits (i=1, j=2, 3)), and Δₗᵢ, Δₘᵢ, Δₙᵢ are a difference in resonance angular frequencies between l-th, m-th, and n-th qubits and the i-th qubit (l, m, n=1, 2, 3, 4, l≠m≠n≠i), and Kᵢ is a parameter representing nonlinearity of the i-th qubit.

(Note 5) In the quantum circuit apparatus according to any one of Notes 1 to 4, for the N qubits, at least one pair of qubits among N(N−1)/2 possible combinations of two qubits have nonlinearity with positive and negative polarities, respectively, such that a cross-Kerr interaction between the one pair of qubits is zero.

(Note 6) The quantum circuit apparatus according to Note 1, includes N qubits, where N is a predetermined integer of 3 or more, coupled via a many-body interaction via a coupler. For these N qubits, at least one pair of qubits among N(N−1)/2 possible combinations of two qubits have nonlinearity with positive and negative polarities, respectively, such that a cross-Kerr interaction between the at least one pair of qubits is zero.

(Note 7) In the quantum circuit apparatus according to any one of Notes 1 to 6, at least one of the N qubits includes a SNAIL (Superconducting Nonlinear Asymmetric Inductive eLement) including a loop in which at least one Josephson junction is connected in parallel to a plurality of Josephson junctions connected in series.

(Note 8) In the quantum circuit apparatus according to any one of Notes 1 to 7, the four qubits and the coupler constitute a basic unit, wherein the quantum circuit apparatus includes a plurality of the basic units arranged to construct a quantum computer.

(Note 9) A control method of a quantum circuit that includes N qubits, where N is a predetermined integer of 3 or more, enabled to be coupled via a many-body interaction, the method comprising:
configuring at least one qubit out of the N qubits with nonlinearity thereof contributing to the many-body interaction; and
configuring remaining one or more qubits out of the N qubits with nonlinearity thereof not contributing to the many-body interaction.

(Note 10) In the method for controlling the quantum circuit according to Note 9, N is set to four, and the many-body interaction is a four-body interaction. Among the four qubits, at least one qubit is directly coupled (DC coupled) to the common node, and remaining qubits are capacitively coupled (AC coupled) to the common node.

The disclosures of each of the above-described documents are hereby incorporated by reference into this document. Within the scope of the disclosure of the present application (including the claims), modifications, adjustments, and combinations of embodiments or examples based on the fundamental technical concept are possible. Furthermore, within the scope of the claims of the present disclosure, various combinations or selections of the disclosed elements (including each element of the appended claims, each element of the embodiments, each element of the drawings, etc.) are possible. That is, the present disclosure naturally encompasses the entire disclosure, including the claims, and various modifications and alterations that would be obvious to one skilled in the art based on the technical concept.

What is claimed is:

1. A quantum circuit apparatus comprising:
N qubits, where N is a predetermined integer of 3 or more, connected to a common node and configured to be coupled via a many-body interaction,
wherein the N qubits include at least one qubit with nonlinearity thereof contributing to the many-body interaction, and one or more qubits with nonlinearity thereof not contributing to the many-body interaction.

2. The quantum circuit apparatus according to claim 1, wherein N is set to four and the many-body interaction is a four-body interaction of four qubits, wherein among the four qubits, at least one qubit is directly coupled to the common node, while remaining qubits are capacitively coupled to the common node.

3. The quantum circuit apparatus according to claim 1, wherein the qubit includes:
a Josephson junction; and/or
a SQUID (Superconducting Quantum Interference Device) with a plurality of Josephson junctions arranged in a loop.

4. The quantum circuit apparatus according to claim 2, where an i-th qubit is directly coupled to the common node as the at least one of the four qubits,
wherein a coupling coefficient h⁽⁴⁾ of the four-body interaction is approximated as the following equation:
$${\tilde{h}}^{( 4 )} ≃ 2 {g}_{12} {g}_{13}^{2} \frac{{K}_{i}}{{Δ}_{li} {Δ}_{mi} {Δ}_{ni}}$$
where gᵢⱼ is the coupling strength between the i-th and j-th qubits (i=1, j=2, 3), and
Δₗᵢ, Δₘᵢ, Δₙᵢ are differences in resonance angular frequencies between the l-th, m-th, and n-th qubits and the i-th qubit (l, m, n=1, 2, 3, 4, l≠m≠n≠i), and
Kᵢ is a parameter representing the nonlinearity of the i-th qubit.

5. The quantum circuit apparatus according to claim 1, wherein at least one pair of qubits among N(N−1)/2 possible combinations of pairs of qubits for the N qubits, are configured to have nonlinearity with positive and negative polarities, respectively, such that a cross-Kerr interaction between the at least one pair of two qubits becomes zero.

6. A quantum circuit apparatus comprising:
a coupler; and
N qubits, where N is a predetermined integer of 3 or more, configured to be coupled through the coupler via a many-body interaction,
wherein at least one pair of qubits among N(N−1)/2 possible combinations of pairs of qubits for the N qubits, are configured to have nonlinearity with positive and negative polarities, respectively, such that a cross-Kerr interaction between the at least one pair of two qubits becomes zero.

7. The quantum circuit apparatus according to claim 1, wherein at least one of the N qubits includes
a Superconducting Nonlinear Asymmetric Inductive eLement (SNAIL) including a loop in which at least one Josephson junction is connected in parallel to a plurality of Josephson junctions connected in series.

8. The quantum circuit apparatus according to claim 2, wherein the four qubits and the coupler constitute a basic unit, wherein the quantum circuit apparatus includes a plurality of the basic units arranged to construct a quantum computer.

9. The quantum circuit apparatus according to claim 1, wherein the nonlinearity is Kerr-nonlinearity of the qubit.

10. A control method of a quantum circuit that includes N qubits, where N is a predetermined integer of 3 or more, enabled to be coupled via a many-body interaction, the method comprising:
configuring at least one qubit out of the N qubits with nonlinearity thereof contributing to the many-body interaction; and
configuring remaining one or more qubits out of the N qubits with nonlinearity thereof not contributing to the many-body interaction.

11. The method according to claim 10, wherein the N is set to four and the many-body interaction is a four-body interaction of four qubits, wherein the method includes:
configuring at least one of the four qubits directly coupled to the common node and remaining one or more qubits of the four qubits capacitively coupled to the common node.

12. The method according to claim 10, comprising:
configuring at least one pair of qubits among N(N−1)/2 possible combinations of pairs of qubits for the N qubits to have nonlinearity with positive and negative polarities, respectively, such that a cross-Kerr interaction between the at least one pair of two qubits becomes zero.

13. The method according to claim 10, wherein the nonlinearity is Kerr-nonlinearity of the qubit.
